(19) United States
(12) Patent Application Publication
(10) Pub. No.: US 2016/0299672 A1
(43) Pub. Date: Oct. 13, 2016

(54) SYSTEMS AND METHODS FOR INITIATING AND MANAGING GROUP COMMUNICATION VIA A MOBILE APPLICATION

(71) Applicant: UNITED ONLINE APPS, INC., Woodland Hills, CA (US)

(72) Inventors: Michel Lindenberg, Erlangen (DE); Dorian Karnbaum, Eckental (DE); Christof Helfrich, Erlangen (DE); Jonathan Weihs, Nueremberg (DE)

(73) Assignee: UNITED ONLINE APPS, INC., Woodland Hills, CA (US)

(21) Appl. No.: 14/684,009

(22) Filed: Apr. 10, 2015

(51) Int. Cl. G06F 3/0484; G06F 3/0482; H04L 29/06

(52) U.S. Cl. CPC G06F 3/04847; H04L 65/403; H04L 65/1069; G06F 3/0482; G06F 3/04842

(57) ABSTRACT

The present embodiments relate to initiating an electronic group conversation or “poll.” According to certain aspects, the group conversation or poll may have an associated topic, a set of choices for the topic, and a set of participants, which may be specified by a user or dynamically determined based on various contextual factors. An electronic device may display the group conversation by indicating the topic and the set of participants, and displaying the set of choices as a set of graphical, interactive user-interface objects. The set of participants may view the group conversation to make selections and input messages, among other functionalities.

### FIELD OF THE DISCLOSURE

The present disclosure generally relates to systems and methods for improved electronic group communication. More particularly, the present disclosure relates to platforms and techniques for enabling a set of users to effectively and efficiently communicate between and among each other for a variety of purposes.

### BACKGROUND

With the proliferation of electronic devices such as smartphones, users are adapting electronic messaging as a means of communication. There are certain existing platforms for enabling communication between or among a set of individuals. For example, one individual may send an SMS message to a group of other individuals, which enables the other individuals to respond to and contribute to a group communication via a series of additional SMS messages. However, these existing platforms do not effectively communicate certain information in a dynamic, graphical manner. Additionally, the existing platforms do not enable the individuals to effectively convey choices, selections, and the like. As a result, the individuals are not able to easily gauge group sentiment, which can hinder certain decision making and general usability of the existing platforms.

Therefore, there is an opportunity for group communication platforms that effectively and efficiently convey information and sentiment in a dynamic, graphical manner, and that similarly enable participants to interact in a more effective manner.

### SUMMARY

In an embodiment, a computer-implemented method on an electronic device of facilitating group communication is provided. The method includes identifying a set of participants for a group communication, receiving, via a user interface, a selection of a topic for the group communication, and enabling a user to select, via the user interface, a set of choices for the topic. The method further includes displaying, via the user interface, the group communication including: indicating the topic and the set of participants, and displaying each of the set of choices as a graphical, interactive user-interface object. The method additionally includes sending, to a remote server via a network connection, a command to cause the set of participants to be invited to the group communication.

In another embodiment, an electronic device configured to facilitate group communication is provided. The electronic device includes a communication module adapted to communicate data, a user interface adapted to display content and receive user input, a memory storing a set of non-transitory computer-executable instructions, and a processor adapted to interface with the communication module and the memory. The processor is configured to execute the set of non-transitory computer-executable instructions to cause the processor to identify a set of participants for a group communication, receive, via the user interface, a selection of a topic for the group communication, and enable a user to select, via the user interface, a set of choices for the topic. The processor is further configured to cause the user interface to display the group communication including: cause the user interface to indicate the topic and the set of participants, and cause the user interface to display each of the set of choices as a graphical, interactive user-interface object. The processor is additionally configured to send, to a remote server via the communication module, a command to cause the set of participants to be invited to the group communication.

In a further embodiment, a computer-implemented method on an electronic device of facilitating group communication is provided. The method includes receiving, from a user via a user interface of the electronic device, a request to initiate a group communication, identifying a set of contextual factors associated with the electronic device, determining a topic for the group communication based on at least a first portion of the set of contextual factors, and identifying a set of participants for the group communication based on at least a second portion of the set of contextual factors. The method further includes enabling the user to select, via the user interface, a set of choices for the topic, and displaying, via the user interface, the group communication including: indicating the topic and the set of participants, and displaying each of the set of choices as a graphical, interactive user-interface object. The method additionally includes sending, to a remote server via a network connection, a command to cause the set of participants to be invited to the group communication.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts a system diagram including various components and entities associated with a group messaging platform, in accordance with some embodiments.

FIG. 2 depicts a signal diagram illustrating communications associated with initiating and facilitating a group communication, in accordance with some embodiments.

FIGS. 3A-3G illustrate exemplary user interfaces associated with a group communication, in accordance with some embodiments.

FIGS. 4A-4E illustrate exemplary user interfaces associated with a group communication, in accordance with some embodiments.

FIG. 5 depicts a flow diagram associated with initiating a group communication, in accordance with some embodiments.

FIG. 6 depicts a flow diagram associated with facilitating a group communication, in accordance with some embodiments.

FIG. 7 is a block diagram of an electronic device, in accordance with some embodiments.

FIG. 8 is a block diagram of a server, in accordance with some embodiments.

### DETAILED DESCRIPTION

The novel systems and methods disclosed herein relate generally to managing electronic group communication. According to certain aspects, a set of electronic devices may support a messaging application having interfaces associated with a group communication, where the messaging application enables a set of participants to make various selections, input messages, and perform other functionalities. The group communication may be initiated by an electronic device and may generally include an associated topic, a set of choices for the topic, and a set of participants. In certain implementations, an originating user may input the topic, the set of choices, and/or the set of participants. In other aspects, the electronic device may automatically determine or identify the topic, the set of choices, and/or the set of participants based on one or more contextual factors associated with the electronic device and/or a user thereof.

The electronic device may cause the set of participants to be invited to the group communication, whereby respective electronic devices of the set of participants may facilitate the group communication via respective user interfaces. In particular, the user interfaces may indicate the topic as well as the set of participants, and may display the set of choices as graphical, interactive user-interface objects that may be selectable or otherwise modified by the set of participants. In response to detecting a selection of one of the set of choices by a participant, the user interface may dynamically modify the corresponding object in various ways including increasing the size of the object, adding an indication of the participant to the object, or other modifications.

The systems and methods discussed herein address a challenge that is particular to electronic group messaging. In particular, the challenge relates to a lack of user participation and engagement in conventional group messaging platforms whereby users are not able to easily assess content included in a group messaging conversation. This is particularly apparent when the users are seeking input that may be used to make a determination or decision. This is additionally apparent when a stream of multiple messages is received within a short time frame. Instead of serially displaying the incoming messages that results in the users having to scroll through a “feed” or otherwise make additional selections, as required by conventional group messaging platforms, the systems and methods dynamically update a single interface to indicate participants' selections. Accordingly, because the systems and methods employ a visual display that dynamically modifies as participants provide input or make selections, the systems and methods are necessarily rooted in computer technology in order to overcome the noted shortcomings that specifically arise in the realm of electronic group messaging.

Similarly, the systems and methods provide improvements in a technical field, namely, electronic messaging. Instead of the systems and methods merely being performed by hardware components using basic functions, the systems and methods employ complex steps that go beyond the mere concept of simply retrieving and combining data using a computer. In particular, the hardware components compile user selections and input, communicate the selections and input between or among a set of devices, assess how to modify graphical, interactive objects, and accordingly modify the graphical, interactive objects, in some cases based on various contextual factors, among other functionalities. This combination of elements impose meaningful limits in that the operations are applied to improve electronic messaging by improving the consolidation of inputs, selections, and contextual factors, and by providing the consolidated data for display on electronic devices in a meaningful and effective way.

The group communication platform as detailed herein therefore offers numerous benefits over conventional messaging platforms. In particular, the group communication platform enables users to effectively initiate a group communication according to a set of manually-entered or automatically-determined parameters which may be relevant to a context of the initiating device and/or initiating user. In response to the set of participants interacting with the group communication, the electronic devices may dynamically modify the appearance of the objects, and the set of participants are able to efficiently and effectively gauge group sentiment without having to read individual messages, scroll through a feed, make additional selections, or perform any manual compilation. The group communication platform further supports messaging and the “pinning” of certain messages that enables an additional communication channel.

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

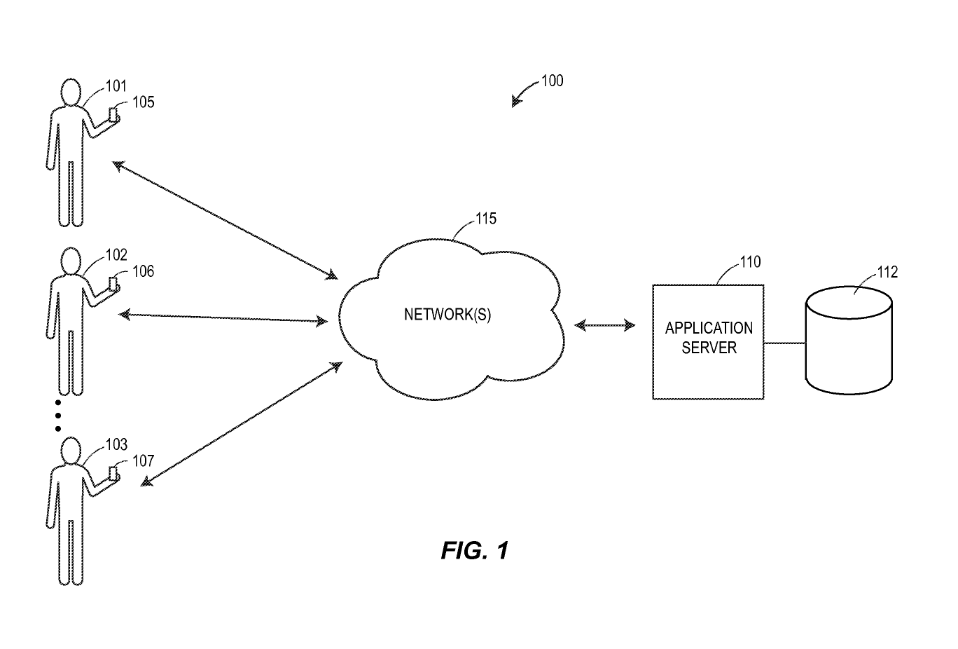

FIG. 1 depicts a system 100 that supports group communications and functionalities relating thereto. Although FIG. 1 depicts certain entities, components, and devices, it should be appreciated that additional or alternate entities and components are envisioned.

As illustrated in FIG. 1, the system 100 includes a set of electronic devices 105, 106, 107. Generally, each of set of electronic devices 105, 106, 107 may be any type of electronic device such as, for example a smartphone, notebook computer, tablet, phablet, GPS (Global Positioning System) or GPS-enabled device, smart watch, smart glasses, smart bracelet, wearable electronic device, PDA (personal digital assistant), pager, computing device configured for wireless communication, and/or the like. Although FIG. 1 depicts three (3) electronic devices 105, 106, 107, it should be appreciated that fewer or additional amounts of electronic devices are envisioned.

Each of the set of electronic devices 105, 106, 107 may participate in a group communication that supports various functionalities. Any of the set of electronic devices 105, 106, 107 may initiate the group communication (i.e., may be a “originating device”) and any of the set of electronic devices 105, 106, 107 may be invited to the group communication (i.e., may be a “recipient device”). For example, the electronic device 105 may be the originating device and the electronic devices 106, 107 may be the recipient devices. As depicted in FIG. 1, each of the electronic devices 105, 106, 107 is capable of being operated by a respective user 101, 102, 103. In particular, the set of users 101, 102, 103 may operate the set of electronic devices 105, 106, 107 to access or view information, make various selections, and facilitate the functionalities described herein.

The system 100 further includes an application server 110 and a database 112. The set of electronic devices 105, 106, 107 and the application server 110 may communicate with each other via one or more networks 115. The network(s) 115 can facilitate any type of data communication via any standard or technology (e.g., GSM, CDMA, TDMA, WCDMA, LTE, EDGE, OFDM, GPRS, EV-DO, UWB, IEEE 802 including Ethernet, WiMAX, Wi-Fi, and/or others). In some implementations, the network(s) 115 may support various short range communications (e.g., Bluetooth®, RFID, NFC) between and among the set of electronic devices 105, 106, 107.

The application server 120 may be a combination of hardware and software components associated with any individual, group of individuals, company, corporation, or other type of entity. According to embodiments, the application server 120 may facilitate various group communication functionalities. In particular, the application server 120 may support and/or interface with a communication platform via which the users 101, 102, 103 may exchange messages, create polls specifying a topic, select choices for the topic, and/or generally communicate. The communication platform may be any type of interface that enables communication such as, for example, a dedicated application, website, and/or the like.

The database 112 may be any type of memory or storage, such as read-only memory (ROM), electronic programmable read-only memory (EPROM), random access memory (RAM), erasable electronic programmable read-only memory (EEPROM), and/or other hard drives, flash memory, MicroSD cards, and others. The database 112 may be configured to store data associated with operation of the communication platform, such as user profile data associated with the users 101, 102, 103, messaging data, and/or other data. The user profile data may include various account data and contact information, such as mobile phone number, e-mail address, name, profile picture, and other information. The database 112 may be further configured to store communications or messages conducted or exchanged via the communication platform, such that the set of electronic devices 105, 106, 107 may access the most recent information (as well as past information) from the database 112 to display to the set of users 101, 102, 103. Accordingly, the application server 110 and the database 112 supports a “cloud”-based implementation for the communication application. In some implementations, the set of electronic devices 105, 106, 107 may be configured to locally store a portion or all of the communication data.

Each of the set of electronic devices 105, 106, 107 may support a communication platform capable of communication with the application server 120 and among the set of electronic devices 105, 106, 107. For example, the communication platform may be a dedicated application, website, and/or the like. The communication platform may display information for review and assessment by the respective users 101, 102, 103, such as via a user interface of the respective devices 105, 106, 107, and may also transmit data and selections to the application server 120.

In operation, the set of electronic devices 105, 106, 107 may support the communication platform to enable the set of users 101, 102, 103 to communicate with each other. In one embodiment, one of the users 101, 102, 103 may create a “poll” having a topic and a set of choices, which the remaining users 101, 102, 103 may access to select one of the choices. The communication platform further supports an interface that enables the users 101, 102, 103 to view and send messages to each other, where the messages may include any textual content, visual content (e.g., images, videos), and/or audio data.

The communication platform may further support various visual features, elements, and objects that uniquely depict the topics and set of choices. For example, if the user 101 creates a poll with a topic and a set of choices, the communication platform may represent the set of choices as a bubble or circle shape (or another shape). Additionally, the set of electronic devices 105, 106, 107 may dynamically adjust or modify the visual features, elements, and objects based on responses and selections of the users 101, 102, 103. Continuing with the example, if the user 102 responds to the poll by selecting one of the choices, the communication platform may reflect the selection by increasing the size of the bubble corresponding to the selected choice. Additionally, the communication platform may indicate who selected a particular choice by displaying an identification of the corresponding user, such as a profile picture, a screen name, or other identifying data. In this regard, the dynamic adjustment or modifications may enable the users 101, 102, 103 to efficiently and effectively assess or gauge the communications and any group sentiment, conclusions, preferences, or results of the communications.

According to embodiments, the communication platform may enable the users 101, 102, 103 to select the participants of a group communication or the communication platform may automatically determine or suggest the participants. Similarly, the communication platform may enable the users 101, 102, 103 to select the topic and set of choices for a group communication, or the communication platform may automatically determine or suggest the topic and set of choices. The communication platform may automatically determine or suggest the participants, the topic, and/or the set of choices using various contextual or environmental data associated with the set of electronic devices 105, 106, 107 and/or with the users 101, 102, 103 thereof. For example, the communication platform may make the determination(s) based on a time of day, a day of week, calendar appointments, activity by one or more other applications executing on the electronic device, certain sensor data such as a location of the set of electronic devices 105, 106, 107, topics of recent or past group communications, and/or other contextual or environmental data.

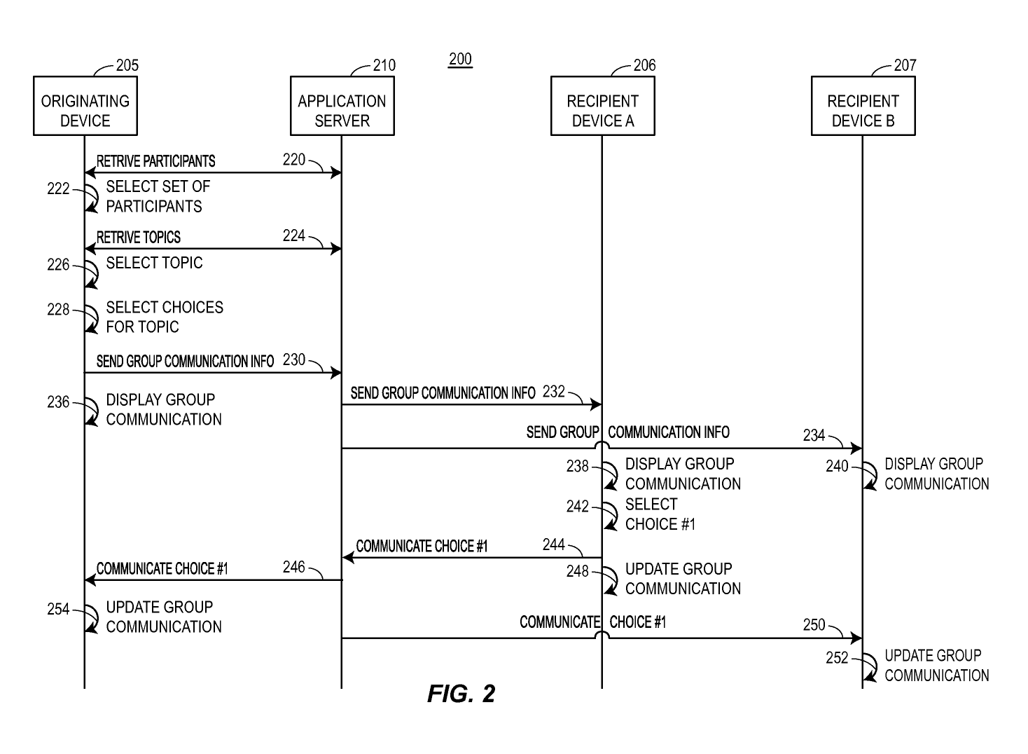

FIG. 2 illustrates a signal diagram 200 describing communications among the various components that may be used to implement the present embodiments. The signal diagram 200 includes an originating device 205 (such as the electronic device 105 as discussed with respect to FIG. 1), an application server 210 (such as the application server 120 as discussed with respect to FIG. 1), a recipient device A 206 (such as the electronic device 106 as discussed with respect to FIG. 1), and a recipient device B 207 (such as the electronic device 107 as discussed with respect to FIG. 1).

Each of the originating device 205, the recipient device A 206, and the recipient device B 207 may be operable by respective users to view/assess information, make selections, and/or input information. Further, each of the originating device 205, the recipient device A 206, and the recipient device B 207 may support a communication platform (e.g., a dedicated application, website, and/or the like) which is capable of communication with the application server 210. In one embodiment, each of the originating device 205, the recipient device A 206, and the recipient device B 207 may install a dedicated application associated with group communication, such as an application offered by and/or supported by the application server 210. In some implementations, at least a portion of the functionalities may be disabled or otherwise not operable without installation of the communication platform on the respective devices 205, 206, 207.

It may be assumed that a user of the originating device 205 wishes to initiate a group communication. Accordingly, referring to FIG. 2, the signal diagram 200 may begin when the originating device 205 retrieves (220) a set of potential participants from the application server 210. In some implementations, the originating device 205 may locally access a set of contacts as the set of potential participants. In other implementations, the originating device 205 may automatically identify the set of potential participants according to one or more parameters. For example, the originating device 205 may identify “favorite” contacts or contacts that frequently participate in group conversations.

Further, the originating device 205 may identify contacts that are relevant or related to a context of the originating device 205 or its user. For example, the originating device 205 may identify contacts that work with the user of the originating device 205. It should be appreciated that additional techniques and/or identification factors for the set of potential participants are envisioned.

The originating device 205 may display the set of potential participants via a user interface and may enable (222) the user to select a set of participants for the group communication. In particular, the user may view the set of potential participants and select which of the set of potential participants to invite to the group communication. In some scenarios, the user may manually identify and specify a participant(s) that is not included in the set of potential participants. For purposes of explanation, it may be assumed that the user selects, as participants, users of recipient device A 206 and recipient device B 207.

The originating device 205 may retrieve (224) a set of topics for the group conversation from the application server 210. In some implementations, the originating device 205 may enable the user to manually input a topic. For example, the user may input, as the topic, “Where should we go for lunch?” In other implementations, the originating device 205 may automatically identify or generate the set of topics according to one or more parameters and/or contextual factors associated with the originating device 205 or its user. According to embodiments, the originating device 205 may facilitate the input/determination of the set of participants and the topic in any order. For example, the originating device 205 may select or enable input of the topic before identifying the set of participants, or vice-versa.

In particular, in identifying or generating the set of topics, the originating device 205 may account for a time of day, a day of week, calendar appointments, various sensor data such as a current location, topics of recent or past group communications, and/or other factors. For example, if the current day or week is Friday and the time of day is 3:30 PM, the originating device 205 may identify/generate the topic “Happy Hour?” For further example, if the user is browsing on a shoe e-commerce website, the originating device 205 may identify/generate the topic “Which shoes do you like best?”

In some implementations, the originating device 205 may analyze any user-entered text to identify the set of topics based on the entered text. In particular, the originating device 205 may perform various semantic or similar analyses on the entered text to dynamically determine one or more topics. For example, if the user enters “What is your favorite”, the originating device 205 may identify the following topics: restaurant, bar, sports team, city, and vacation destination. After retrieving, identifying, or generating the set of topics, the originating device 205 may display the set of topics via the user interface. Accordingly, the originating device 205 may enable the user to select (226) a topic from the set of topics or, in some cases, to manually input a topic.

In addition to selecting the set of participants and the topic, the originating device 205 may enable (228) selection of choices for the topic. Similar to the set of participants and the topic identifications, the originating device 205 may identify, determine, or retrieve the choices for the topic according to various techniques. In one implementation, the originating device may retrieve a set of choices from the application server 210, such as a set of default choices that may or may not be related to the selected topic. In some implementations, the originating device 205 may enable the user to manually input the choices. For example, if the topic is “Where should we go for lunch?”, the choices may be “Mexican restaurant,” “Chinese restaurant,” and “Burger restaurant.” In other implementations, the originating device 205 may automatically identify or generate the set of choices according to one or more parameters and/or contextual factors associated with the originating device 205 or its user.

In particular, in identifying or generating the set of choices, the originating device 205 may account for a time of day, a day of week, calendar appointments, various sensor data such as a current location, topics of recent or past group communications, and/or other factors. For example, if the topic is “Happy Hour?”, then the originating device 205 may identify its current location and identify nearby bars or restaurants including “ABC Bar,” “Main Lounge,” and “Loop Tap.” For further example, if the topic is “Which shoes do you like best?”, then the originating device 205 may retrieve, from a shoe e-commerce website that the user may be browsing, various shoes that are offered for sale via the website. As an additional example, if the topic is “What is your favorite workout?”, then the originating device 205 may interface with a peripheral device and/or with an additional application to identify any completed or logged workouts.

After retrieving, identifying, or generating the set of choices, the originating device 205 may display the set of choices via the user interface. In particular, the originating device 205 may display the set of choices as a set of visual features, elements, or objects. As described herein, the originating device 205 may display the set of choices as a set of graphical, interactive user-interface objects. The displayed set of choices thus enable the users of the devices 205, 206, 207 to efficiently and effectively assess the topic and the choices, as well as make a desired selection. It should be appreciated that a wide variety of visual features, elements, or objects for the set of choices are envisioned.

After the participants, the topic, and the choices for the topic (i.e., the “group communication information”) have been ascertained, the originating device 205 may send (230) the group communication information to the application server 210. After receipt of the group communication information, the application server 210 may send (232) the group communication information to recipient device A 206 and send (234) the group communication information to recipient device B 207. The group communication information may include a request to join the group communication. The respective recipient devices 206, 207 may notify the respective users of the group communication (e.g., via a push notification), and the respective recipient devices 206, 207 may enable the respective users to select whether to join the group communication. In some implementations, the recipient devices 206, 207 may automatically join the group communication.

The originating device 205 may display or indicate (236) the group communication. In particular, the originating device 205 may display the topic and the choices for the topic, as well as any other graphic or textual content. As discussed above, the originating device 205 may display each of the choices for the topic as a graphical, interactive user-interface object. For example, the graphical, interactive user-interface object may be a circle or sphere object. It should be appreciated that other types of graphical, interactive user-interface objects are envisioned, such as any two-dimensional or three-dimensional shape of varying sizes.

The originating device 205 may also indicate the participants of the group communication. For example, the originating device 205 may display a profile picture for each of the participants. It should be appreciated that the originating device 205 may indicate the participants according to other techniques or elements. Each of recipient device A 206 and recipient device B 207 may similarly display (238, 240) the group communication. In some implementations, recipient device A 206 and recipient device B 207 may display the group communication after the respective users have selected to join the group communication.

After displaying the group communication, each of the originating device 205 and the recipient devices 206, 207 may enable its respective user to make selections or otherwise interact with the group communication. In particular, the users may select any of the choices for the topic (and may also “unselect” a selected choice). It should be appreciated that the users may make selections according to various gestures (e.g., “drag and drop” or multiple selection) or techniques. Further, the devices 205, 206, 207 may enable respective users to message each other with alphanumeric, graphical, or audio messages.

In an exemplary embodiment as illustrated in FIG. 2, recipient device A 206 may receive a selection of example “choice #1” for the topic. For example, the user of recipient device A 206 may “drag and drop” his or her displayed indication into a vicinity of a graphical, interactive user-interface object corresponding to choice #1. Recipient device A 206 may also communicate (244) choice #1 to the application server 210. After receipt of choice #1, the application server 210 may relay (246, 248) the communication of choice #1 to each of the originating device 205 and to recipient device B 207.

After recipient device A 206 receives the selection for “choice #1”, recipient device A 206 may update (248) the group communication to reflect the choice. In embodiments, recipient device A 206 may modify the graphical, interactive user-interface object corresponding to choice #1. In particular, device A 206 may increase the size of the graphical, interactive user-interface object, and add, to the graphical, interactive user-interface object, the indication corresponding to the user of recipient device A 206. For example, recipient device A 206 may add the profile picture of its user to the corresponding selected object. It should be appreciated that other graphical updates to the group communication are envisioned. Each of the originating device 205 and recipient device B 207 may also similarly update (254, 252) the group communication. In this regard, the respective users of the respective devices 205, 206, 207 may efficiently and effective assess how the users have “voted” or otherwise gauge which choices have been selected, the users who have made choices, and which choices have not been selected.

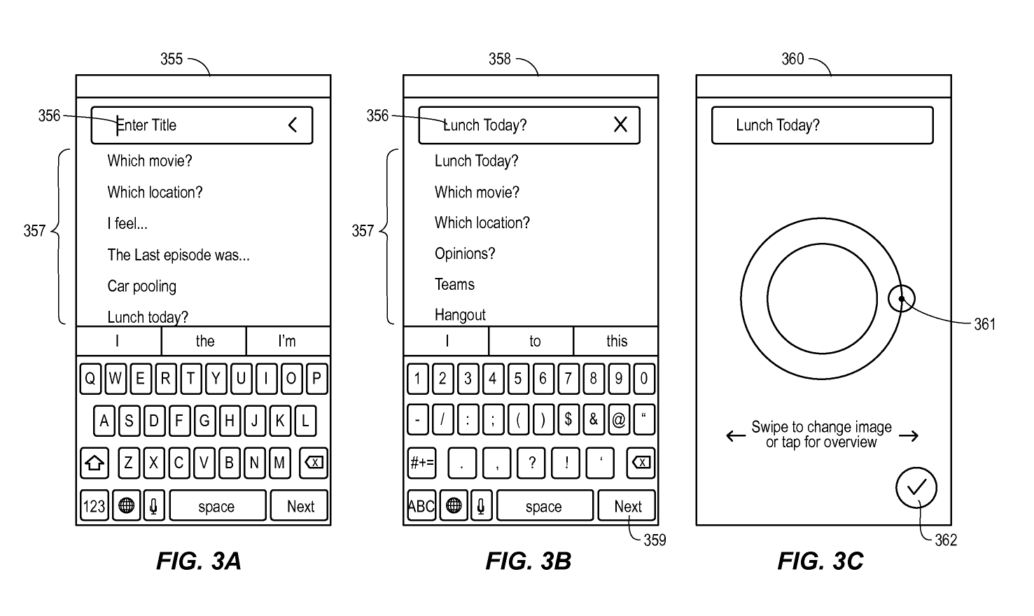

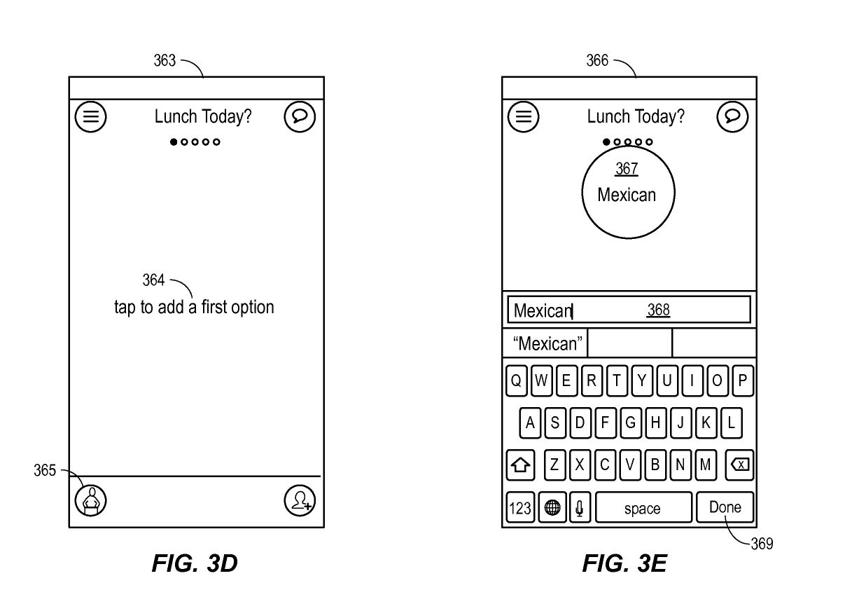

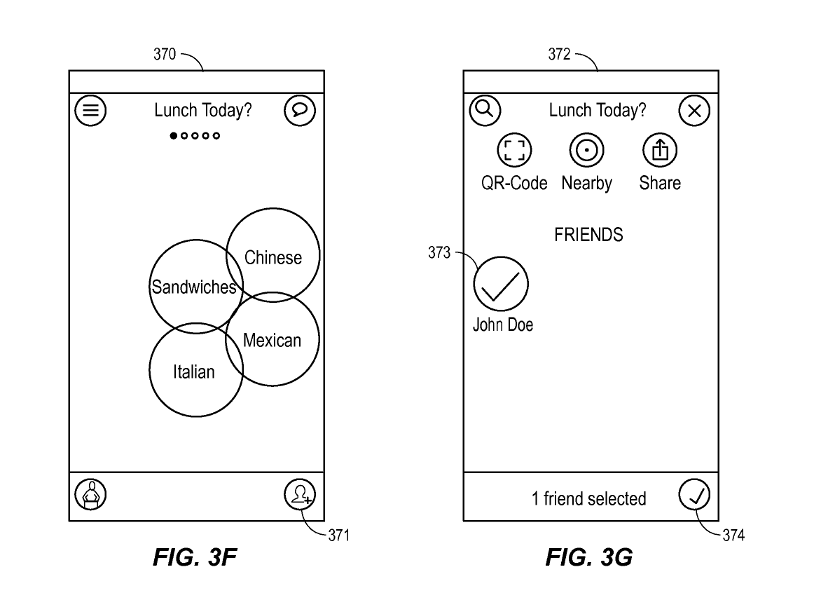

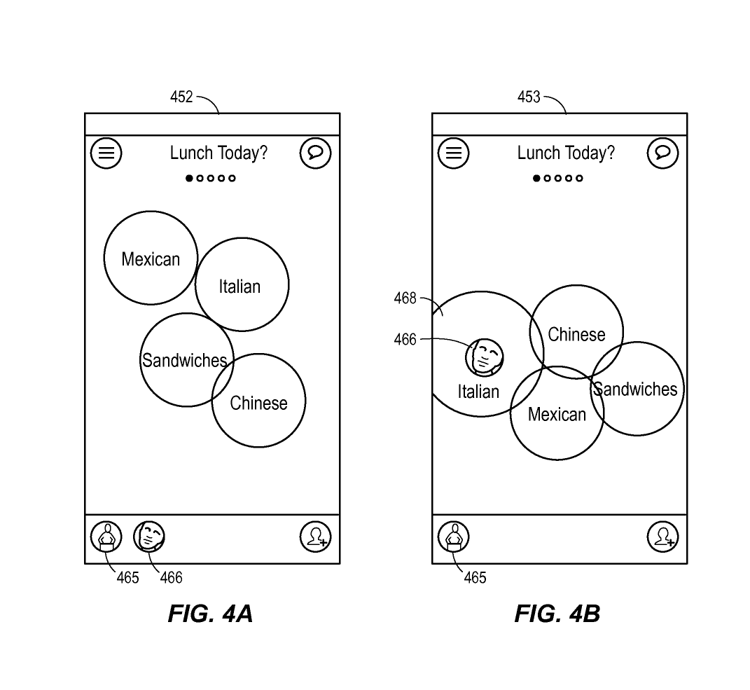

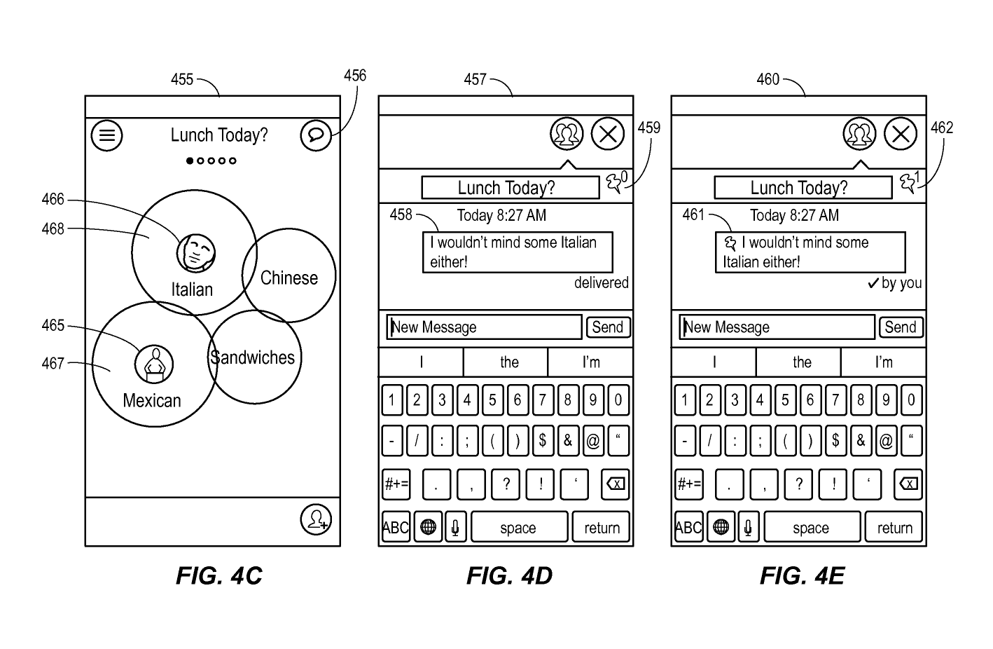

FIGS. 3A-3G and 4A-4E illustrate exemplary interfaces associated with a group communication between and among a set of participants. An electronic device (e.g., a mobile device such as a smartphone) may be configured to display the interfaces and/or receive selections and inputs via the interfaces. For example, a communication platform such as a dedicated application that is configured to operate on the electronic device may display the interfaces. It should be appreciated that the interfaces are merely exemplary and that alternative or additional content is envisioned.

FIGS. 3A-3G include interfaces that are associated with initiating a group communication by a user. An electronic device that may belong to the user may display the interfaces of FIGS. 3A-3G. Referring to FIG. 3A, an interface 355 enables the user to input a topic for the group communication. In some implementations, the electronic device may display the interface 355 in response to receiving an appropriate selection (e.g., a “new poll” selection) by the user. The interface 355 includes a topic input area 356 into which the user may input the topic according to understood techniques. For example, the user may use a keyboard or voice dictation to input or dictate the topic. The interface 355 further includes a set of topic suggestions 357. In some implementations, the set of topic suggestions 357 may be a default set. In other implementations, the electronic device may generate the set of topic suggestions 357 based on an environment or context of the electronic device (e.g., time of day, location, or other factors), previously-inputted or recently-used topics, and/or other information.

FIG. 3B depicts an interface 358 after the user has input a portion or all of a topic into the topic input area 356. As shown in FIG. 3B the user has input the topic “Lunch Today” into the topic input area 356. In some implementations, the electronic device may dynamically modify the set of topic suggestions 357 based on a portion or all of the inputted topic. The interface 358 includes a “Next” selection 359 that enables the user to proceed to the next interface.

In response to the user selecting the “Next” selection 359, the electronic device may display an interface 360 as depicted in FIG. 3C. The interface 360 enables the user to modify the theme or other display elements of the group communication interface. In the implementation as shown in FIG. 3C, the interface 360 may include a color selection option 361 that enables the user to select a background color for the interface 360 and for the resulting group communication interface. The interface 360 may further enable the user to “swipe” left or right to change the background image displayed in the interface 360. It should be appreciated that the interface 360 supports alternative or additional display modification functionalities. Further, although not shown in FIG. 3C, the interface 360 could display certain parameters for user selection that the electronic device may use to identify choices for the entered topic. For example, for the topic “Lunch Today,” the interface 360 may enable the user to enter or select a restaurant price class or tier, a location, and a type of cuisine. The interface 360 further includes a complete selection 362 that enables the user to proceed to the next interface.

In response to the user selecting the complete selection 362, the electronic device may display an interface 363 as depicted in FIG. 3D. The interface 363 enables the user to add choices for the topic (“Lunch Today?”) by selecting a portion 364 of the interface 363. In the implementation depicted in FIG. 3D, the user may input one or more choices by “tapping” the portion 364. The interface 363 further includes an indication 365 of the user. As depicted, the indication 365 may be a profile picture that may be selected by the user. It should be appreciated that alternate indications for the user are envisioned. For example, the indication may include certain identifying information of the user.

If the user selects the area 364, the electronic device may display an interface 366 as depicted in FIG. 3E. The interface 366 includes an input area 368 that enables the user to enter a choice for the topic. As depicted in FIG. 3E, the user enters “Mexican” as a choice for the topic. While the user enters the choice, the interface 366 may update an object 367 that represents the entered choice. According to embodiments, the object 367 may be a graphical, interactive user-interface object that may indicate the choice (as shown: “Mexican”). In some implementations, the choices for the topic may be represented as a label, an image, a video, an audio snippet, any metadata including links, or some other type of media object or combination of multiple media objects. For example, for the choice of “Mexican”, the object 367 may display an image of a taco.

As depicted in FIG. 3E, the object 367 is a circle or “bubble.” However, it should be appreciated that additional shapes and sizes are appreciated. The interface 366 further includes a “Done” selection 369 that, when selected, may create the entered choice and finalize the corresponding object 367. In some implementations, the electronic device may automatically identify one or more choices for the topic based on a context of the electronic device, as discussed herein. In this scenario, the electronic device may present the identified choices via the user interface for selection by the user.

FIG. 3F depicts an interface 370 that indicates a set of four (4) choices that were input for the topic “Lunch Today?”: Mexican, Chinese, Sandwiches, and Italian. Each of the set of four (4) choices may be created according to the functionalities as described with respect to FIGS. 3D and 3E. Further, each of the set of four (4) choices may be represented by a graphical, interactive user-interface object (as depicted: circles or “bubbles”). The interface 370 may include an “add contact” selection 371 that enables the user to invite additional users to the group communication.

In response to the user selecting the “add contact” selection 371, the electronic device may display an interface 372 as depicted in FIG. 3G. The interface 372 may display a list of users who may be contacts of the user and/or who may be invited to the group communication. According to embodiments, the list of users may be “connections” of the user within the dedicated application, may be contacts of the user, or may otherwise be affiliated with the user. The list of users may alternatively or additionally include users who are not affiliated with or connected to the user. The electronic device may enable the user to manually enter or search for a contact, such as via a name, a phone number, or other type of identification information.

The electronic device may further enable the user to locate nearby users who may or may not be affiliated with the user and who the user may want to add to the group communication. As depicted in FIG. 3G, the user may select an indication 373 of a user to add to the group communication. Further, the user may select a “complete” selection 374 to finish adding users to the group communication. Although FIG. 3G depicts the user adding a single additional user to the group communication, it should be appreciated that the user may add any number of additional users to the group communication.

FIGS. 4A-4E include interfaces that are associated with facilitating a group communication, such as the group communication described with respect to FIGS. 3A-3G. Similar to the interfaces of FIGS. 3A-3G, an electronic device that may belong to the user may display the interfaces of FIGS. 4A-4E.

In response to the user selecting the “complete” selection 374 of FIG. 3G, the electronic device may display an interface 452 as depicted in FIG. 4A. The interface 452 includes the set of choices for the topic “Lunch Today?”. Further, the interface 452 includes indications 465, 466 for the users or participants of the group communication. When the users are invited and join the group communication, each respective electronic device belonging to the users may display the same or similar interface as the interface 452.

Additionally, each respective electronic device may enable the respective user to make a selection of one of the choices. To make a selection in one implementation, a user may “drag and drop” his or her indication to a vicinity of the object corresponding to the desired choice, where the electronic device may then associate that user with the selected choice. It should be appreciated that other techniques for making a selection of one of the choices are appreciated. For example, the user may “double tap” a desired choice, or may first tap his or her indication and then tap the desired choice. In some implementations, each respective electronic device may enable the respective user to select more than one choice, such as by enable the respective user to “drag and drop” his or her indication into multiple objects. Additionally, each respective electronic device may enable the respective user to rank or prioritize her or her choices, which the electronic device may indicate or display accordingly.

FIG. 4B depicts an interface 453 that the electronic device may display after detecting that a user has selected a choice. In particular, the user corresponding to the indication 466 has selected the “Italian” choice, as evidence by the indication 466 included in an object 468 corresponding to the “Italian” choice. In response to the electronic device detecting the selected choice, the electronic device may modify the object 468 accordingly. In one implementation, the electronic device may increase the size of the object 468 and may add the indication 466 of the corresponding user to the object 468.

Additionally, there may be a movement vector associated with the user selecting the object 468, where the movement vector may have a direction and magnitude corresponding to the gesture that the user uses to select the object 468 (e.g., a “drag and drop” gesture). The electronic device may identify the movement vector and may relocate or move the object 468 within the interface 453 according to the movement vector. The electronic device may also modify the interface 453 according to various sensor data. For example, the electronic device may retrieve gyroscope or accelerometer data and may relocate the object 468 and other objects according to an “augmented reality” technique.

FIG. 4C depicts an interface 455 that the electronic device may display after detecting an additional choice selection by an additional user. In the embodiment as depicted in FIG. 4C, the additional user may the user of the electronic device. The additional user corresponding to the indication 465 has selected the “Mexican” choice, as evidenced by the indication 465 included in an object 467 corresponding to the “Mexican” choice. In response to the electronic device detecting the selected choice, the electronic device may modify the object 467 accordingly. In one implementation, the electronic device may increase the size of the object 467 and may add the indication 465 of the corresponding user to the object 467.

Additionally, there may be a movement vector associated with the additional user selecting the object 467, where the movement vector may have a direction and magnitude corresponding to the gesture that the additional user uses to select the object 467 (e.g., a “drag and drop” gesture). The electronic device may identify the movement vector and may relocate or move the object 467 within the interface 455 according to the movement vector. The electronic device may also modify the interface 455 according to various sensor data. For example, the electronic device may retrieve gyroscope or accelerometer data and may relocate the object 467 and other objects according to an “augmented reality” technique.

The electronic device may further support electronic messaging between and among the users of the group communication. The electronic messaging may enable the users to ask and answer questions related to the topic and the set of choices, or otherwise contribute additional messages or content. It should be appreciated that the electronic messaging may be between all the users or participants of a group communication, or between a subset of the users (e.g., a 1-to-1 communication between two users).

FIG. 4D depicts an interface 457 associated with the electronic messaging feature. In some implementations, the electronic device may display the interface 457 in response to a selection of a message selection 456 included in the interface 455 of FIG. 4C. The interface 457 may enable the corresponding user to input a message, for example an alphanumeric message or visual/audio content. The interface 457 may also enable the user to “post” a message 458, at which point the message may be viewable by any of the users of the group communication. In some implementations, any users who make a common selection of an object may be able to communicate or view message(s) separate from other users who select a different object. For example, if three (3) users select the object 468 of FIG. 4C corresponding to “Italian,” then these three (3) users may be able to communication among each other and separate from users who select other objects.

The interface 457 may further enable a user to “pin” a message via a “pin” selection 459. “Pinning” a message may enable various improvements and features, including: enabling users to filter the messages to view only the pinned messages, generating a push notification when a message is pinned, and enabling any users who later join the group communication to have access to any pinned messages (but to not have access to any “unpinned” messages). It should be appreciated that additional improvements and features for pinned messages are envisioned. FIG. 4E depicts an interface 460 including a pinned message 461. In particular, the user may facilitate pinning the message 458 of FIG. 4D by “dragging and dropping” the “pin” selection 459 onto the message 458. Accordingly, the interface 460 may display the pinned message 461. The interface 460 further includes a modified “pin” selection 462 that, when selected, may cause the electronic device to display any pinned messages.

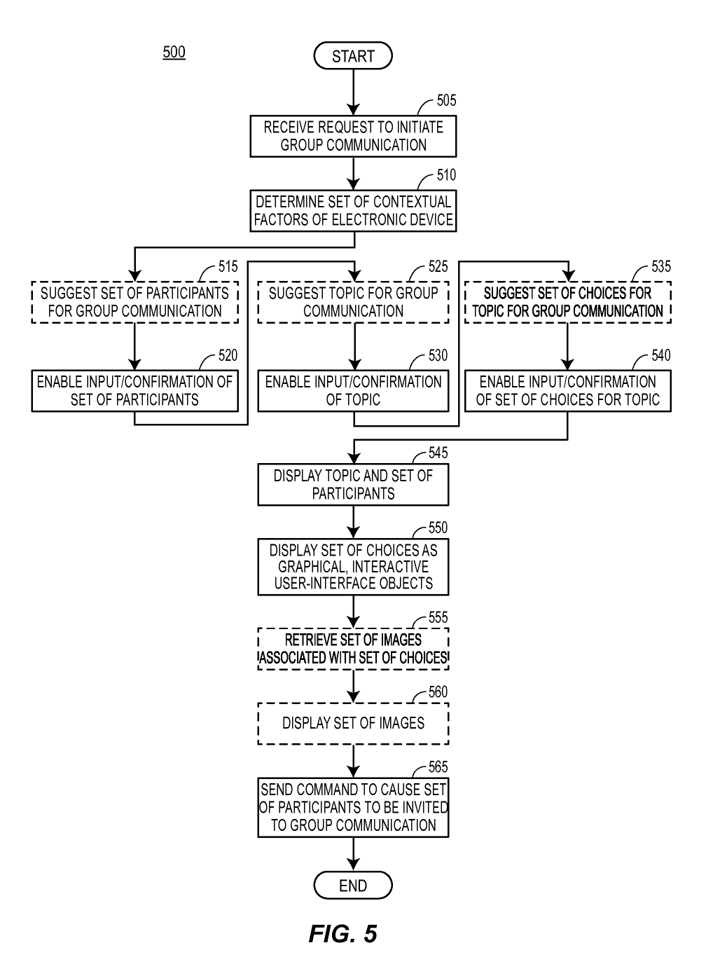

Referring to FIG. 5, depicted is a block diagram of an example method 500 for initiating and facilitating a group communication. The method 500 may be facilitated by an electronic device, such as one of the electronic devices 105, 106, 107 as discussed with respect to FIG. 1. The electronic device may be configured to communicate with a remote server, such as the application server 110 as discussed with respect to FIG. 1. Further, the electronic device may support and execute a dedicated application that may perform one or more of the outlined steps.

The method 500 may begin with the electronic device receiving (block 505) a request from a user to initiate a group communication. In particular, the user may make an appropriate selection on a dedicated application to initiate the group communication. The electronic device may determine (block 510) a set of contextual factors associated with the electronic device. In embodiments, the set of contextual factors may include any of: a time of day, a day of week, calendar appointments, activity by one or more other applications executing on the electronic device, certain sensor data such as a location of the electronic device, a set of contacts, topics of recent or past group communications, and/or other contextual or environmental data. The set of contextual factors may additionally include other data stored on the electronic device, such as “favorite” or “preferred” contacts of the user, previously or frequently-used topics or choices for the topics, and/or other data that may be relevant to a group communication.

The electronic device may optionally suggest (block 515) a set of participants for the group communication. In particular, the electronic device may identify the set of participants based on one or more of the contextual factors, or based on other information. For example, if the set of contextual factors indicates that the electronic device is located at a workplace of the user, then the electronic device may identify co-workers of the user who may or may not be contacts of the user. In another example, the electronic device may identify “favorite” or “preferred” contacts of the user. The electronic device may suggest the set of participants by indicating the set of participants via a user interface.

The electronic device may enable (block 520) the user to input or confirm the set of participants for the group communication. In particular, the electronic device may enable the user to select any or all of the set of participants that the electronic device suggested in block 515. In some implementations, the user may manually input one or more participants to be added to the set of participants.

The electronic device may optionally suggest (block 525) a topic for the group communication. In particular, the electronic device may identify the topic based on one or more of the contextual factors, or based on other information such as the set of participants. For example, if the set of contextual factors indicates that it is a Saturday night, then the electronic device may identify the topic as “Plans Tonight?”. In another example, if the set of contextual factors indicates that the user recently browsed for books on an e-commerce platform, then the electronic device may identify the topic as “Book Recommendations?”. The electronic device may also suggest one or more recently-used topics, popular topics, “trending” topics, or other relevant topics. The electronic device may suggest the topic by displaying the topic via the user interface.

The electronic device may enable (block 530) the user to input or confirm the topic for the group communication. In particular, the electronic device may enable the user to select any topic that the electronic device suggested in block 525. In some implementations, the user may manually input the topic for the group communication.

The electronic device may optionally suggest (block 535) a set of choices for the topic for the group communication. In particular, the electronic device may identify the set of choices based on one or more of the contextual factors, or based on other information such as the set of participants and/or the topic. For example, if the topic is “Lunch Today?”, then the electronic device may identify, as the set of choices, the nearest five (5) restaurants. In another example, if the set of contextual factors indicates that the user recently browsed for books on an e-commerce platform, then the electronic device may identify the set of choices as any of the books that the user browsed. The electronic device may also suggest one or more recently-used choices, popular choices, “trending” choices, or other relevant choices. The electronic device may suggest the set of choices by displaying the set of choices via the user interface.

The electronic device may enable (block 540) the user to input or confirm the set of choices for the topic for the group communication. In particular, the electronic device may enable the user to select any choices that the electronic device suggested in block 535. In some implementations, the user may manually input the set of choices for the topic for the group communication. According to embodiments, the electronic device may facilitate the input/determination of the set of participants, the topic, and the set of choices for the topic (blocks 515-540) in any order. For example, the electronic device may facilitate the input/determination of the topic before the input/determination of the set of participants.

After the electronic device has facilitated the input/determination of the set of participants, the topic, and the set of choices for the topic, the electronic device may display or indicate (block 545) the topic and the set of participants in the user interface. In embodiments, the electronic device may display or indicate the set of participants as a set of indications. For example, each participant may have an associated profile picture.

The electronic device may also display (block 550), via the user interface, the set of choices as graphical, interactive user-interface objects. According to embodiments, the graphical, interactive user-interface objects may be any size and/or shape, and may be selectable by any of the set of participants, or the set of participants may otherwise interact with the graphical, interactive user-interface objects.

The electronic device may optionally retrieve or access (block 555) a set of images that may be associated with the set of choices. In some embodiments, the electronic device may access the set of images that may be stored locally on the electronic device. In other embodiments, the electronic device may retrieve the set of images from a remote server. For example, the electronic device may retrieve the set of images from a website server that the user may be browsing, where the set of images correspond to the set of choices. The electronic device may accordingly display (block 560) the set of images. In some implementations, the electronic device may overlay or include the set of images within the set of graphical, interactive user-interface objects.

The electronic device may send (block 565) a command to a remote server to cause the set of participants to be invited to the group communication. In particular, the electronic device may transmit, to the remote server, the information associated with the group communication (e.g., the topic, the set of choices, and the set of participants), and the remote server may accordingly send an invitation or request to a set of electronic devices associated with the set of participants to join the group communication. In some embodiments, the set of participants may automatically join the group communication. In other embodiments, the set of participants may select whether to join the group communication. After the set of participants join the group communication, the set of participants may participate in the group communication by making selections, sending messages, and performing other functionalities.

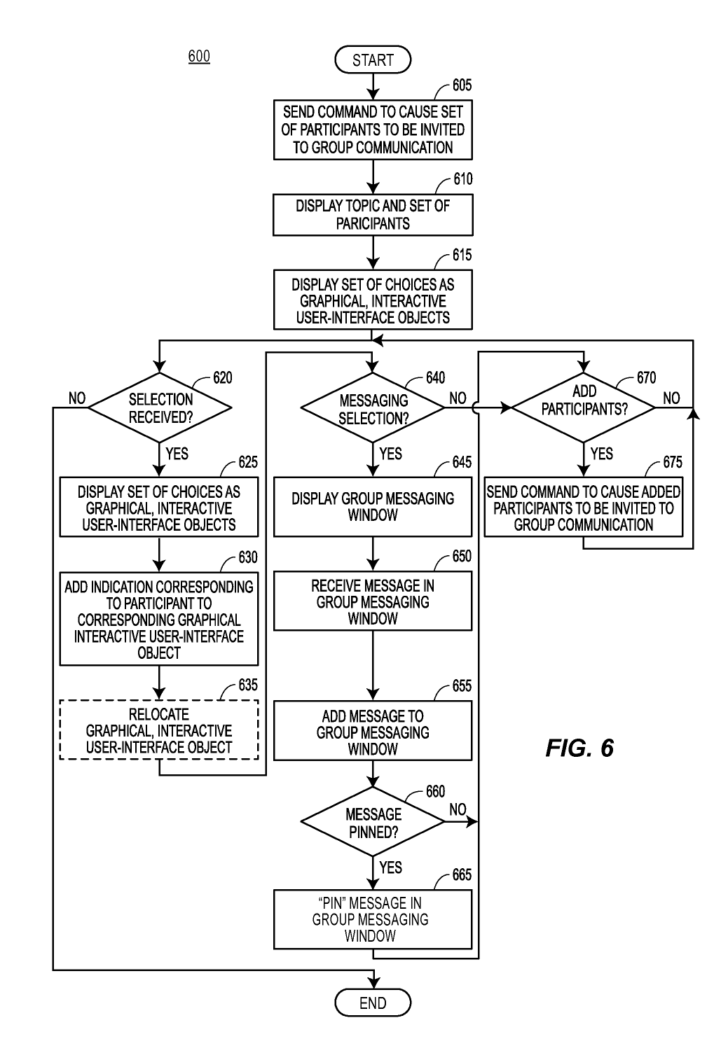

Referring to FIG. 6, depicted is a block diagram of an example method 600 for facilitating a group communication. The method 600 may be facilitated by an electronic device, such as one of the electronic devices 105, 106, 107 as discussed with respect to FIG. 1. The electronic device may be configured to communicate with a remote server, such as the application server 110 as discussed with respect to FIG. 1. Further, the electronic device may support and execute a dedicated application that may perform one or more of the outlined steps.

The electronic device may perform the method 600 in conjunction with performing the method 500 of FIG. 5. In particular, prior to performing the method 600, the electronic device may have received or determined information associated with a group communication (e.g., the topic, the set of choices, and the set of participants).

The method 600 may begin with the electronic device sending (block 605) a command to a remote server to cause a set of participants to be invited to a group communication. It should be appreciated that performing block 605 may include the same or similar functionalities as performing block 565 of the method 500. In particular, the electronic device may transmit, to the remote server, the information associated with the group communication (e.g., the topic, the set of choices, and the set of participants), and the remote server may accordingly send an invitation or request to a set of electronic devices associated with the set of participants to join the group communication. In some embodiments, the set of participants may automatically join the group communication. In other embodiments, the set of participants may select whether to join the group communication.

The electronic device may additionally display or indicate (block 610) the topic and the set of participants in a user interface. In embodiments, the electronic device may display or indicate the set of participants as a set of indications. For example, each participant may have an associated profile picture. The electronic device may also display (block 615), via the user interface, the set of choices as graphical, interactive user-interface objects. According to embodiments, the graphical, interactive user-interface objects may be any size and/or shape, and may be selectable by any of the set of participants, or the set of participants may otherwise interact with the graphical, interactive user-interface objects.

The electronic device may determine (block 620) whether a selection by a participant corresponding to one of the choices is received. The selection may be from the user of the electronic device or may correspond to a selection made by one of the other set of participants. If a selection is not received, such as if the user selects to exit the group communication platform or after a certain timeout period (“NO”), processing may proceed to any other functionality or may end.

If a selection is received (“YES”), the electronic device may modify the graphical, interactive user-interface object corresponding to the selected choice. In particular, the electronic device may increase (block 625) a size of the corresponding graphical, interactive user-interface object, so as to reflect the selected choice. Further, the electronic device may add (block 630) or associate an indication corresponding to the selecting participant to the corresponding graphical, interactive user-interface object. For example, the electronic device may add a profile picture associated with the selecting participant to the corresponding graphical, interactive user-interface object.

In an optional implementation, the electronic device may relocate (block 635) the graphical, interactive user-interface object within the user interface. The relocation may be based on a movement vector corresponding to the selection of the choice. In particular, the movement vector may correspond to the participant “dragging and dropping” a corresponding indication onto the choice. Alternatively, the electronic device may determine how to relocate the object according to various sensor data collected by the electronic device (e.g., accelerometer data or gyroscope data).

The electronic device may further determine (block 640) whether a messaging selection has been received. In particular, the messaging selection may correspond to functionality to enable the set of participants to input messages for viewing by the other participants. If a messaging selection has not been received (“NO”), processing may proceed to block 670 or to other processing. If the messaging selection has been received (“YES”), the electronic device may display (block 645) a group messaging window in the user interface. The electronic device may display, if present, any messages previously input into the group messaging window by the set of participants.

The electronic device may receive (block 650) a message in the group messaging window via the user interface, such as from the user of the electronic device. The electronic device may accordingly add (block 655) the message to the group messaging window to be accessed or viewed by the set of other participants. The electronic device determine (block 660) whether the user has selected to “pin” the message for perpetual display. If the user has not selected to “pin” the message (“NO”), processing may proceed to block 670 or to other functionality. If the user has selected to “pin” the message (“YES”), the electronic device may “pin” the message in the group messaging window. In particular, the electronic device may indicate that the message is for perpetual display.

Processing may proceed to block 670 in which the electronic device may determine whether the user has selected to add any additional participants to the group communication. If the electronic device determines that no participants have been selected to add to the group communication (“NO”), processing may return to block 620. In contrast, if the electronic device determines that participant(s) have been selected to add to the group communication (“YES”), the electronic device may send (block 675) a command to the remote server to cause the additional participant(s) to be invited to the group communication, similar to the functionality of block 605.

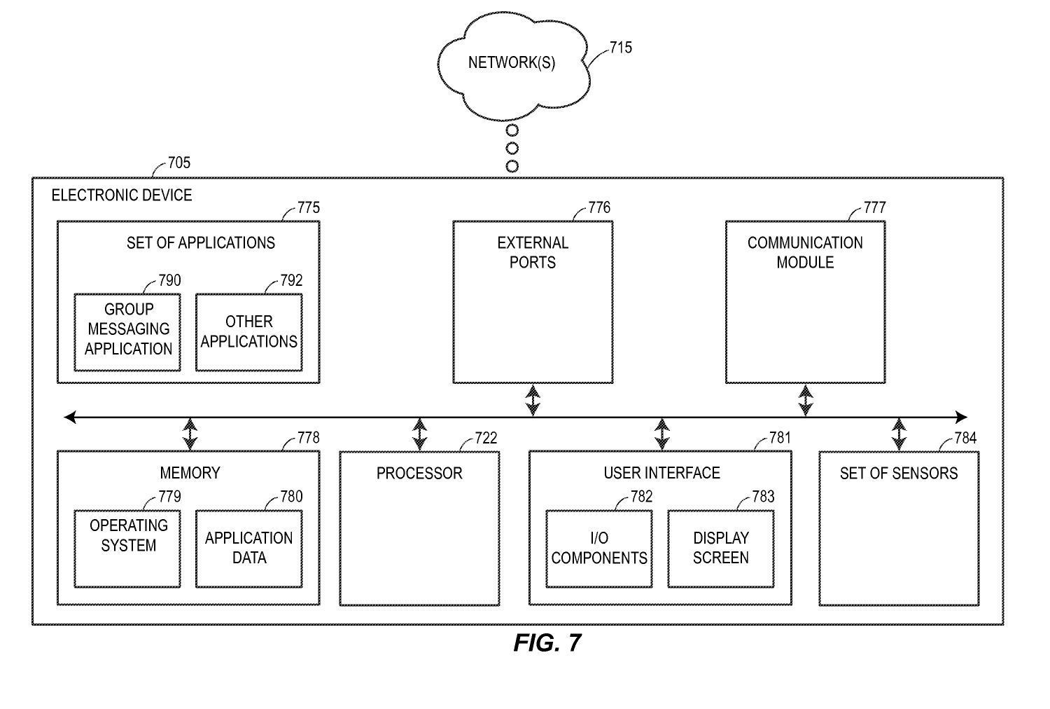

FIG. 7 illustrates a diagram of an exemplary electronic device 705 (such as the electronic device 105 as discussed with respect to FIG. 1) in which the functionalities as discussed herein may be implemented.

The electronic device 705 may include a processor 722 as well as a memory 778. The memory 778 may store an operating system 779 capable of facilitating the functionalities as discussed herein as well as a set of applications 775 (i.e., machine readable instructions). For example, one of the set of applications 775 may be a group messaging application 790 configured to enable individuals to communicate with each other. It should be appreciated that one or more other applications 792 are envisioned.

The processor 722 may interface with the memory 778 to execute the operating system 779 and the set of applications 775. According to some embodiments, the memory 778 may also store application data 780 that includes information related to the group messaging application 790, such as profile data and any received/inputted messages. The memory 778 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 705 may further include a communication module 777 configured to communicate data via one or more networks 715. According to some embodiments, the communication module 777 may include one or more transceivers (e.g., WWAN, WLAN, and/or WPAN transceivers) functioning in accordance with IEEE standards, 3GPP standards, or other standards, and configured to receive and transmit data via one or more external ports 776. For example, the communication module 777 may receive, from a back-end server via the network 715, a selection of choice associated with the group messaging application 790. Further, the communication module 777 may include a short-range network component (e.g., an RFID reader) configured for short-range network communications.

The electronic device 705 may further include a user interface 781 configured to present information to a user and/or receive inputs from the user. As shown in FIG. 7, the user interface 781 may include a display screen 782 and I/O components 783 (e.g., ports, capacitive or resistive touch sensitive input panels, keys, buttons, lights, LEDs, speakers, microphones). According to some embodiments, the user may access the electronic device 705 via the user interface 781 to make various selections, log into any of the set of applications 775, and/or perform other functions. The electronic device 705 may further include a set of sensors 784 such as, for example, one or more accelerometers, imaging sensors (e.g., cameras), proximity sensors, gyroscopes, location modules (e.g., a GPS chip), ultrasonic sensors, infrared sensors, and others.

In some embodiments, the electronic device 705 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 722 (e.g., working in connection with the operating system 779) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

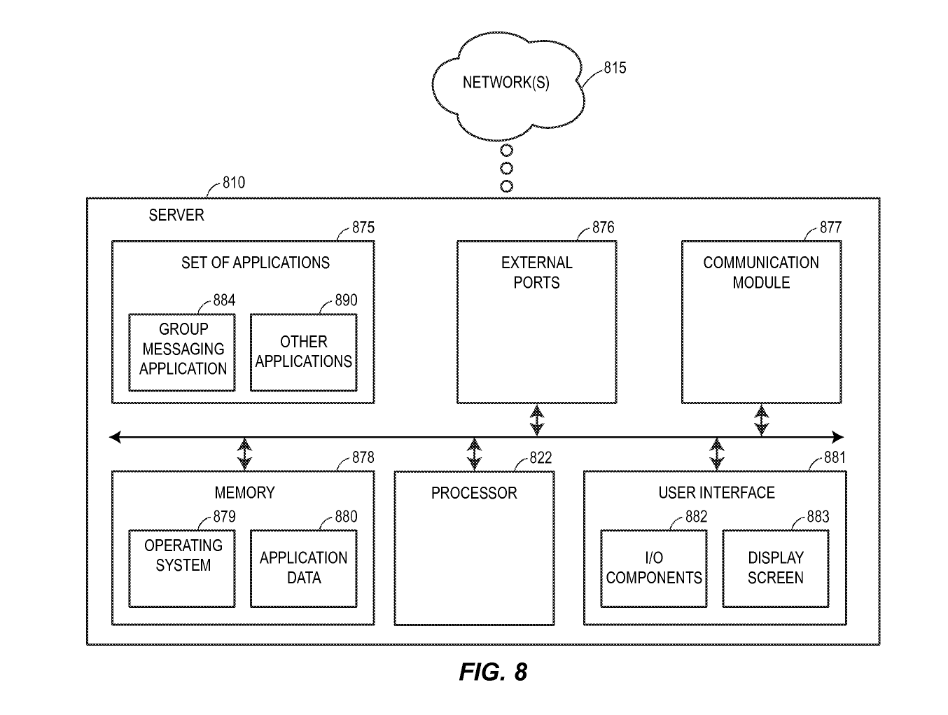

FIG. 8 illustrates a diagram of an exemplary server 810 (such as the application server 110 as discussed with respect to FIG. 1) in which the functionalities as discussed herein may be implemented.

The server 810 may include a processor 822, as well as a memory 878. The memory 878 may store an operating system 879 capable of facilitating the functionalities as discussed herein as well as a set of applications 875 (i.e., machine readable instructions). For example, one of the set of applications 875 may be a group messaging application 884 configured to enable individuals to communicate with each other. It should be appreciated that one or more other applications 890 are envisioned.

The processor 822 may interface with the memory 878 to execute the operating system 879 and the set of applications 875. According to some embodiments, the memory 878 may also store application data 880 that may include various data associated with operation of the group messaging application 884, such as user profile data, and any messages and data relating thereto. The memory 878 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 810 may further include a communication module 877 configured to communicate data via one or more networks 815. According to some embodiments, the communication module 877 may include one or more transceivers (e.g., WWAN, WLAN, and/or WPAN transceivers) functioning in accordance with IEEE standards, 3GPP standards, or other standards, and configured to receive and transmit data via one or more external ports 876. For example, the communication module 877 may receive, via the network 815, messages and choice selections from devices participating in a group communication.

The server 810 may further include a user interface 881 configured to present information to a user and/or receive inputs from the user. As shown in FIG. 8, the user interface 881 may include a display screen 882 and I/O components 883 (e.g., ports, capacitive or resistive touch sensitive input panels, keys, buttons, lights, LEDs, speakers, microphones). According to some embodiments, the user may access the server 810 via the user interface 881 to process various user accounts and/or perform other functions. In some embodiments, the server 810 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 822 (e.g., working in connection with the operating system 879) to facilitate the functions as described herein. In this regard, the program code may be implemented in any desired language, and/or may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A computer-implemented method on an electronic device of facilitating group communication, the method comprising:
identifying a set of participants for a group communication;
receiving, via a user interface, a selection of a topic for the group communication;
enabling a user to select, via the user interface, a set of choices for the topic;
displaying, via the user interface, the group communication including:
indicating the topic and the set of participants, and
displaying each of the set of choices as a graphical, interactive user-interface object; and
sending, by a processor to a remote server via a network connection, a command to cause the set of participants to be invited to the group communication.

2. The computer-implemented method of claim 1, wherein identifying the set of participants for the group communication comprises:
enabling the user to specify, via the user interface, the set of participants for the group communication.

3. The computer-implemented method of claim 1, wherein identifying the set of participants for the group communication comprises:
receiving, via the user interface, (i) a first selection of a first participant of the set of participants and (ii) a second selection of a second participant of the set of participants;
identifying, from profile data, a common characteristic shared by the first participant and the second participant;
identifying an additional user that shares the common characteristic; and
adding the additional user to the set of participants.

4. The computer-implemented method of claim 1, wherein receiving the selection of the topic for the group communication comprises:
determining a set of topics for the group communication;
displaying the set of topics via the user interface; and
receiving, via the user interface, the selection of the topic from the set of topics.

5. The computer-implemented method of claim 4, wherein determining the set of topics for the group communication comprises:
identifying a contextual factor associated with the electronic device; and
determining the set of topics based on the contextual factor.

6. The computer-implemented method of claim 1, wherein displaying each of the set of choices as the graphical, interactive user-interface object comprises:
retrieving, via the network connection, a set of media objects associated with the set of choices, and
indicating a respective media object of the set of media objects within the corresponding graphical, interactive user-interface object.

7. The computer-implemented method of claim 1, wherein enabling the user to select, via the user interface, the set of choices for the topic comprises:
identifying a contextual factor associated with the electronic device;
determining a set of potential choices for the topic based on the contextual factor, the set of potential choices including at least the set of choices;
displaying the set of potential choices via the user interface; and
receiving, from the user via the user interface, a set of selections corresponding to the set of choices.

8. An electronic device configured to facilitate group communication, comprising:
a communication module adapted to communicate data;
a user interface adapted to display content and receive user input;
a memory storing a set of non-transitory computer-executable instructions; and
a processor adapted to interface with the communication module and the memory, and configured to execute the set of non-transitory computer-executable instructions to cause the processor to:
identify a set of participants for a group communication,
receive, via the user interface, a selection of a topic for the group communication,
enable a user to select, via the user interface, a set of choices for the topic,
cause the user interface to display the group communication including:
cause the user interface to indicate the topic and the set of participants, and
cause the user interface to display each of the set of choices as a graphical, interactive user-interface object, and
send, to a remote server via the communication module, a command to cause the set of participants to be invited to the group communication.

9. The electronic device of claim 8, wherein to identify the set of participants for the group communication, the processor is configured to:
enable the user to specify, via the user interface, the set of participants for the group communication.

10. The electronic device of claim 8, wherein to identify the set of participants for the group communication, the processor is configured to:
receive, via the user interface, (i) a first selection of a first participant of the set of participants and (ii) a second selection of a second participant of the set of participants,
identify, from profile data, a common characteristic shared by the first participant and the second participant,
identify an additional user that shares the common characteristic, and
add the additional user to the set of participants.

11. The electronic device of claim 8, wherein to receive the selection of the topic for the group communication, the processor is configured to:
determine a set of topics for the group communication,
cause the user interface to display the set of topics, and
receive, via the user interface, the selection of the topic from the set of topics.

12. The electronic device of claim 11, wherein to determine the set of topics for the group communication, the processor is configured to:
identify a contextual factor associated with the electronic device, and
determine the set of topics based on the contextual factor.

13. The electronic device of claim 8, wherein to cause the user interface to display each of the set of choices as the graphical, interactive user-interface object, the processor is configured to:
access a set of media objects associated with the set of choices, and
cause the user interface to indicate a respective media object of the set of media objects within the corresponding graphical, interactive user-interface object.

14. The electronic device of claim 8, wherein to enable the user to select, via the user interface, the set of choices for the topic, the processor is configured to:
identify a contextual factor associated with the electronic device,
determine a set of potential choices for the topic based on the contextual factor, the set of potential choices including at least the set of choices,
cause the user interface to display the set of potential choices, and
receive, from the user via the user interface, a set of selections corresponding to the set of choices.

15. A computer-implemented method on an electronic device of facilitating group communication, the method comprising:
receiving, from a user via a user interface of the electronic device, a request to initiate a group communication;
identifying a set of contextual factors associated with the electronic device;
determining, by a processor, a topic for the group communication based on at least a first portion of the set of contextual factors;
identifying a set of participants for the group communication based on at least a second portion of the set of contextual factors;
enabling the user to select, via the user interface, a set of choices for the topic;
displaying, via the user interface, the group communication including:
indicating the topic and the set of participants, and
displaying each of the set of choices as a graphical, interactive user-interface object; and
sending, by the processor to a remote server via a network connection, a command to cause the set of participants to be invited to the group communication.

16. The computer-implemented method of claim 15, wherein enabling the user to select, via the user interface, the set of choices for the topic comprises:
determining a set of potential choices for the topic based on at least a third portion of the set of contextual factors, the set of potential choices including at least the set of choices;
displaying the set of potential choices via the user interface; and
receiving, from the user via the user interface, a set of selections corresponding to the set of choices.

17. The computer-implemented method of claim 15, wherein identifying the set of contextual factors comprises:
identifying at least one of: a current time, a current location, and a calendar appointment.

18. The computer-implemented method of claim 15, wherein identifying the set of participants for the group communication comprises:
identifying a set of frequent contacts of the user.

19. The computer-implemented method of claim 15, wherein identifying the set of contextual factors comprises:
identifying a current time;
and wherein determining the topic for the group communication comprises:
determining the topic for the group communication based on the current time.

20. The computer-implemented method of claim 15, wherein identifying the set of contextual factors comprises:
identifying a current location of the electronic device;
and wherein identifying the set of participants for the group communication comprises:
identifying the set of participants for the group communication based on the current location of the electronic device.
